(19) United States
(12) Patent Application Publication
(10) Pub. No.: US 2008/0193902 A1
(43) Pub. Date: Aug. 14, 2008

(54) Beverage game

(76) Inventor: Grae Verlin, Warren, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/704,901

(22) Filed: Feb. 9, 2007

(51) Int. Cl. G09B 19/00

(52) U.S. Cl. 434/127; 434/128

(57) ABSTRACT

A game and a method of playing a game that allows the players to gain a familiarity with the various characteristics of specific beverages. The game board provides for interchangeable maps that depict the region in which the beverages are produced. The game provides the players with an opportunity to identify tastes and smells that are attributable to the beverage.

### BACKGROUND OF THE INVENTION

The present disclosure relates to an interactive board game and a method for teaching individuals about attributes of specific beverages.

Beverages such as wine, coffee, and beer, come from various regions and come in numerous varieties. For example, it is well known that a wine will have its own unique smell, color, and flavor as a result of the grapes used in the wine, the region in which the grapes are grown, and the process used to produce the wine. People who wish to gain appreciation for these distinctions will typically invest time and energy in learning the characteristics and terminology associated with the beverage. For those who are novices in the field, it can become daunting to make sense of all the various forms and distinctions these beverages can have. In order to learn more about the types of beverages available, it has become popular for individuals to read books, take classes, and travel to beverage tastings. However, these methods can be expensive, time consuming, and will often require the individual to learn about the beverage outside of the social setting in which the beverage is normally enjoyed.

The present invention overcomes these shortcomings by providing a game in which individuals can learn about the characteristics and terminology associated with various types of specific beverages, while also enjoying those beverages among friends and family.

### SUMMARY OF THE INVENTION

A game is provided in one aspect of the present invention a game board having a plurality of game pieces, and a plurality of maps illustrating distinct regions in which the beverages are produced. Some of the game pieces may include cards that contain questions and information related to the beverages. A subset of the cards contains general information that is independent of the region from which the beverages are produced. Another subset of the cards contains specific information that is dependent upon the region from which the beverages are produced.

In another aspect of the game, each team is assigned a beverage label that designates that team's specific beverage. At the beginning of each round the team's beverage label is empty, and it is the object of the game to collect beverage label pieces that designate certain attributes of the specific beverage.

In yet another aspect of the game, the beverage label pieces are removably attachable to the beverage label.

In still another aspect of the game, the maps are removably attachable to the game board.

In another aspect of the game, a player is blindfolded and is asked to identify an item that relates to a particular beverage based on its smell.

In yet another aspect of the game, a player is blindfolded and is asked to identify an item that relates to a particular beverage based on its taste.

In still another aspect of the game each player is given a placemat. The placemats contain areas on which glasses may be placed. The placemats also contain areas on which interchangeable maps and beverage labels may be placed, so as to designate the beverages and regions that are currently involved in the game.

### BRIEF DESCRIPTION OF THE DRAWINGS

FIG. 1 illustrates a plurality of game pieces in accordance with an embodiment of the present invention.

FIG. 2 illustrates a game board in accordance with an embodiment of the present invention.

FIG. 3 illustrates a placemat in accordance with an embodiment of the present invention.

FIG. 4 illustrates a beverage label with interchangeable label pieces.

FIG. 5 illustrates a game board have a plurality of interchangeable maps.

### DETAILED DESCRIPTION

The beverage game disclosed herein allows players to become familiar with all of the various characteristics of beverages that are produced from harvested crops, such as wine, coffee, or beer. Through performing the unique steps of the beverage game, players will become knowledgeable of the beverage's specific characteristics, including variety, vintage, flavor, color, and smell. In addition, the players will become knowledgeable of the conditions which bring about the characteristics of each beverage and the region in which the beverage is produced.

In one embodiment of the present game, two or more players are divided into at least two teams, and each team is assigned a label that designates a specific brand or type of beverage. As the game progresses, each team will have the opportunity to acquire various label pieces, which will correspond to the beverage that has been assigned to that team. For example, if each team has been assigned a wine label, the teams will attempt to acquire label pieces listing the vintage, vineyard, producer, and village of the wine the team has been assigned. The initial objective of the game is to accumulate the corresponding components to the beverage label. Those pieces will be attached to the team's label, such as by magnet, Velcro, or a mechanical fastener. Once all four components of the label are acquired, that team is considered to “own the vineyard” associated with that label. Once a team owns their respective vineyard, the next flight, or round, begins. In the next flight, each team will each be assigned a new label that represents a new wine. At the end of a predetermined number of flights, the team with the most completed labels is designated the winner.

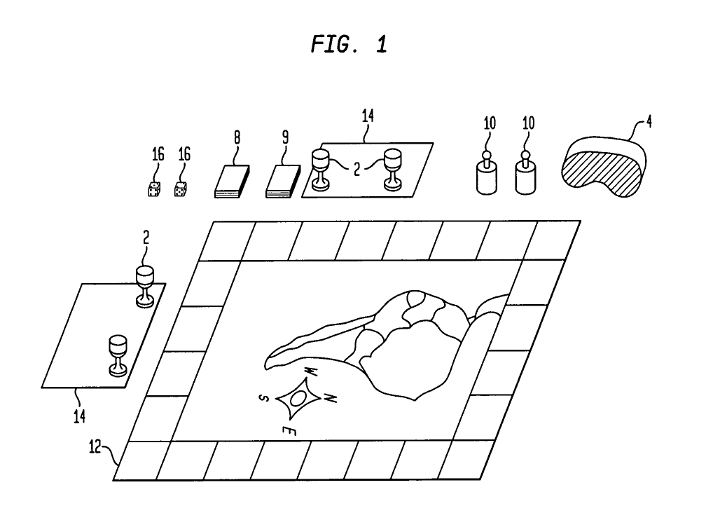

As shown in FIG. 1, a preferred embodiment of the present game includes drinking glasses 2, blindfolds 4, game pieces 6, game cards 8, aroma containers 10, a game board 12, placemats 14, dice 16, a timer 17, and beverage labels 19.

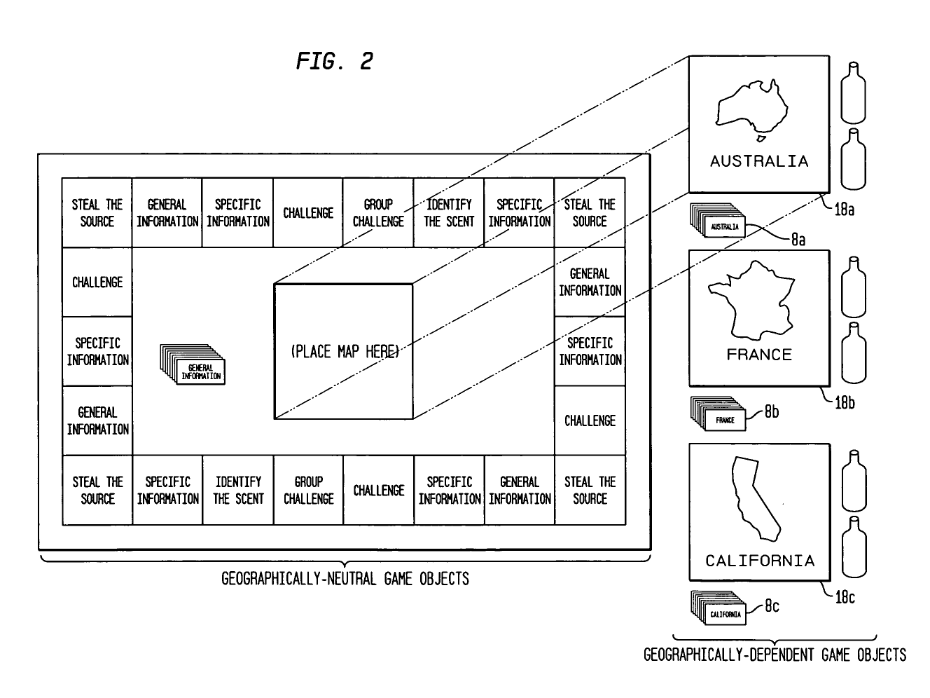

As shown in FIG. 2, the game board 12 contains at its center a map area 17 on which an interchangeable map 18 may be placed. The map 18 corresponds to the geographic location wherein the beverages of the two teams are produced, and may be interchanged during or between games, so as to allow the players to experience beverages that are produced in a variety of regions. The map may contain the locations and names of all of the producers of that type of beverage which can be found in the geographic region depicted by the map 18. For example, the map 18a may depict Goulburn Valley, Australia, 18b may depict Burgundy, France, and 18c may depict Napa Valley, Calif. Each map would also contain the location and names of the various vineyards found in its particular region. Preferably, the beverage will be associated with the displayed geographic region. The game board 12 also contains along its periphery a plurality of squares or spaces 20, which serve as areas on which the team may move its game piece. As shown in FIG. 2, the game may also include different sets of Specific Information Cards 8a-8c, with each set of Specific Information Cards 8 including questions or information that correspond with the specific region depicted on the maps 18a-18c. In that regard, the game preferably includes both geographically neutral game objects and geographically specific game objects, where the geographically specific objects can be easily changed from game to game, and some of the geographically specific objects can be affixed to the geographically neutral objects (such as the game board).

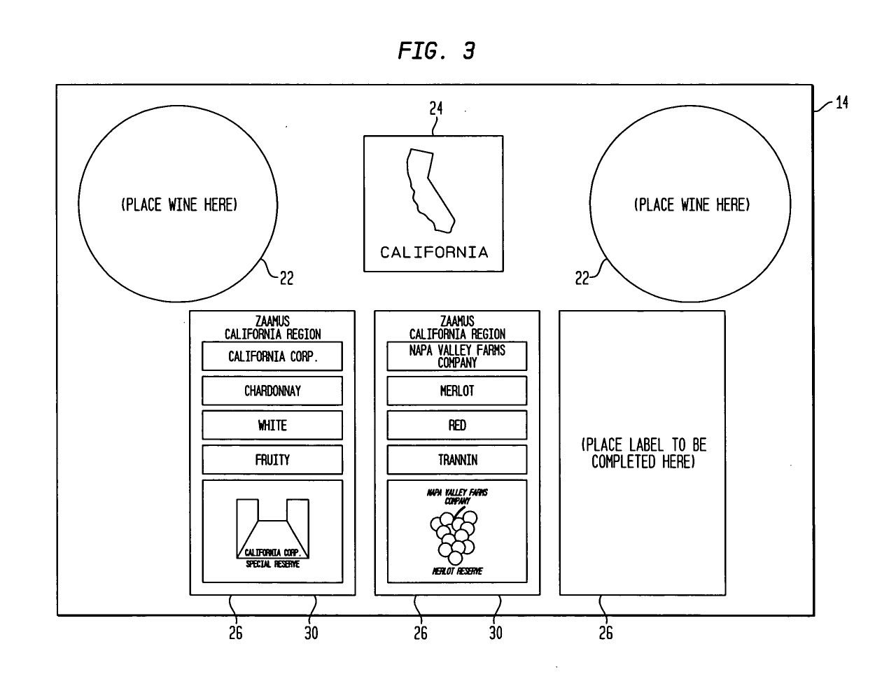

As shown in FIG. 3, the placemats 14 contain two circles 22, a map area 24, and label areas 26. The two circles 22 designate where a player may place his or her drinking glasses 2, and the map area 24 allows for an placemat map 28 to be attached to the placemat 14, That corresponds to the map 18 that is placed on the game board 12. The label areas 26 allow for a completed beverage label 30 to be attached to the placemat 14 at the beginning of each round, so as to represent the pieces that the team must collect during each round.

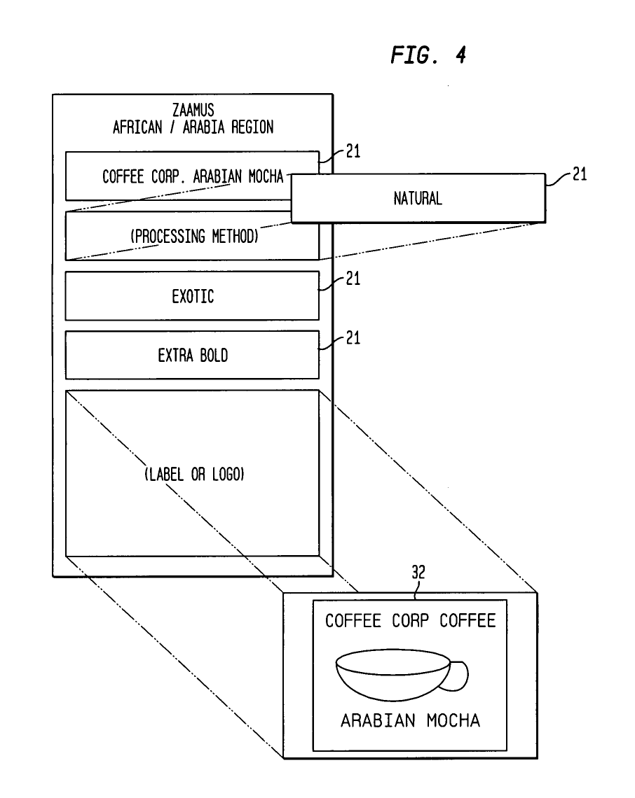

FIG. 4 illustrates the beverage label 19 that is completed by the team during each round of the game. The to-be-completed beverage label 19 contains individual label pieces 21 and a picture 32 of the label as seen on the beverage itself. Each label piece 21 can be individually attached to the beverage label 19, so that at the beginning of each round each team is provided with at least one empty beverage label 19. As a team acquires label pieces 21 through the round, they may place those pieces 21 onto the beverage label 19. Each label piece provides information about the product, such as variety, brand, region and color with respect to the wine, or (as shown in FIG. 4), the brand, processing method, key term, classification and logo with respect to coffee. Thus, the game may include both preprinted completed cards (representing the goal of the player) and cards to be completed with removable pieces (representing the progress of the player towards that goal).

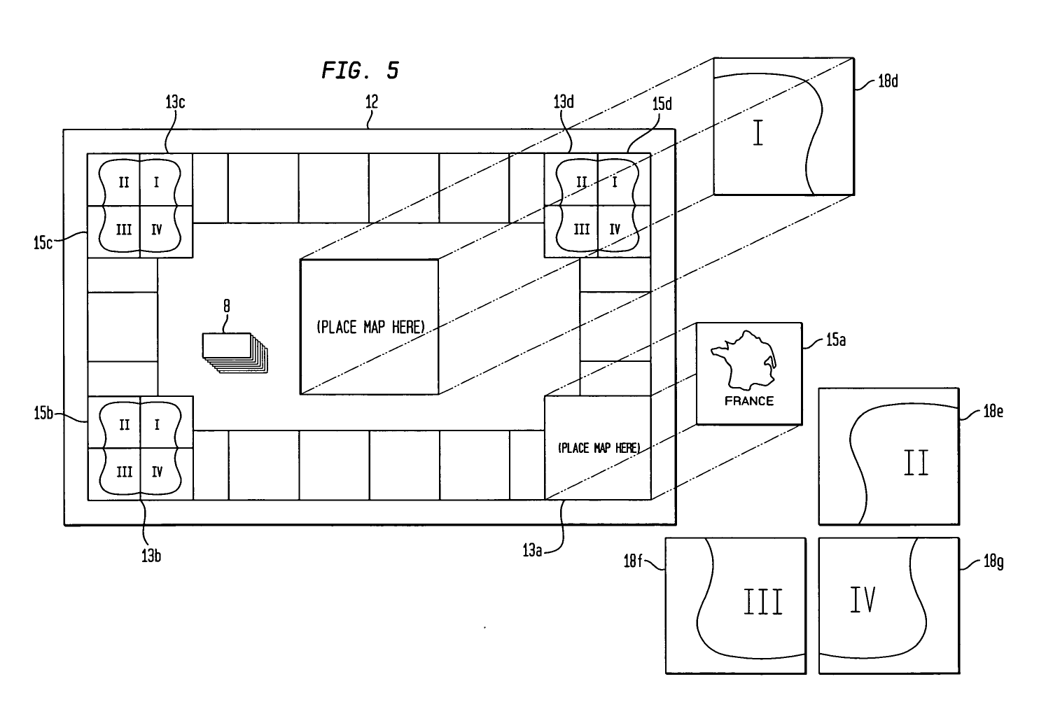

In another embodiment of the present game, the game board 12 may contain a plurality of maps that illustrate a particular country or region with different degrees of specificity. As shown in FIG. 5, each of the corner spaces 13 of the game board 12 can contain an interchangeable map 15. The maps 15 will each depict the region shown in the center map 18, but will also depict the surrounding regions as well. For example, the players of this embodiment might use the game to learn about the wines that come from Burgundy, France. In this instance, the center map 18d might depict a specific part of Burgundy, France. In turn, one of the corner spaces 13a could contain a map 15a depicting all of France, and other corners 13b-13d could contain maps 15b-15d illustrating the entire Burgundy region. As the game progresses into later rounds, the center map 18d can be replaced with other center maps 18e-18g, each depicting a different region of Burgundy shown in the corner maps 15. Preferably, the set of Specific Information cards 8 will relate to the entire Burgundy region, and will therefore remain constant between each round. In this way, the players can travel throughout the Burgundy region and use the combination of corner maps 15 and center maps 18 to determine where they have traveled. Similarly, the placemat 14, as shown in FIG. 3, could be used in this embodiment to either depict the entire Burgundy region, or particular parts of Burgundy.

Preferably, the interchangeable maps, label pieces, and beverage labels are attached in a way that allows for ease of application and removal; however they may be attached to the game board 12 or placemats 14 in any variety of ways. For example, they may be attachable to the game board 12 or placemat 14 through the use of magnets, Velcro, or mechanical fasteners.

At the beginning of the game, each team selects a game piece 6 that will represent their team and places the game piece 6 at the starting space 34. A captain for each team is also selected based on the flip of a coin or themed game piece, such as a cork. The two captains then flip a game piece to determine which team will have the first turn.

The team having the first turn will proceed by rolling a die 16. That team will then move its game piece 6 from the starting space 34 by the number of spaces 20 corresponding to the number identified by the die 16. Each space 20 has one of a plurality of designations which will inform the player of the action that is required upon landing on that particular space. The designation may include the following: General Information, Specific Information, Challenge, Group Challenge, Identify the Scent, and Steal the Source. Each space may also include a brief description of what the player is to do.

Upon a game piece landing on a space designated as Specific Information, a player from that team will select a card from a stack of game cards 8 that are labeled “Specific Information.” The player will then read aloud to the opposing team the question contained on the card, which may or may not be in a multiple choice format. The questions contained on the Specific Information cards will relate in some way to the two specific beverages that have been assigned to the teams. For example, if the teams are playing the present game with wines that are from Burgundy, France, the questions on the Specific Information cards will all relate to Burgundy, France and wine from Burgundy, France. The opposing team will then attempt to answer the question within the time allotted by the timer 17. If the opposing team answers correctly, that team will receive a piece of their label. If the opposing team answers incorrectly or can not answer within the allotted time, that team will receive nothing, and it will become that team's turn to roll the die.

Upon a game piece landing on a space designated as General Information, a player from that team will select a card from a stack of game cards 9 that are labeled “General Information.” The player will then read aloud to the opposing team the question contained on the card, which may or may not be in a multiple choice format. The questions contained on the General Information cards will relate in some way to the general beverage that is being used in the game, such as wine, coffee, or beer. For example, if the teams are playing with wine, the General Information cards will all contain questions that directly or indirectly relate to wine. Once the card is read the timer will be started. The opposing team will then attempt to answer the question. If the opposing team answers correctly, that team will receive a piece of their label. If the opposing team answers incorrectly or can not answer within the allotted time, that team will receive nothing and it will become that team's turn to roll the die.

Upon a game piece landing on a space designated as Challenge, one player from that team will participate in a challenge, which will require that player to put on a blindfold. The captain of the opposing team will then choose one of the two beverages being used in that game. The player participating in the challenge smells the beverage that has been selected by the opposing captain, and may also smell the beverages contained in the two drinking glasses 2 that are on the player's placemat 14. The captain of the team being challenged may assist the participating player by placing the beverages in the player's hand. Once the player has had an opportunity to smell each of the beverages, the timer is started. The player may wish to smell the beverages again, and may do so as long as the player is still within the time allotted. The player then states which beverage he or she believes was selected by the opposing captain. If the player's guess is correct, that player's team receives a label piece. If the player is incorrect or can not answer in the allotted time, then the opposing team rolls the die and takes its turn.

The first player to participate in the challenge for each team will be the player that sits to the right-hand side of the team captain. Each successive challenge will be performed by the player sitting to the right-hand side of the player that had performed the previous challenge.

The same procedure followed for a challenge space, is also performed when a game piece 6 lands on an Identify the Scent space. However in this instance, a scent tincture or sample of an ingredient scent, such as blackberry, is placed under the blindfolded player's nose, and the player must identify the scent. The players may decide at the beginning of the game to omit the Identify the Scent. In this case, the teams will move to the next space on the board, upon landing on an Identify the Scent space.

If a game piece 6 lands on a space designated as Group Challenge, half of the players from that team will participate in the challenge by putting on a blindfold. The captain of the opposing team will then choose one of the two beverages being used in that game. The players participating in the challenge smell the beverage that has been selected by the opposing captain, and may also smell the beverages contained in the two drinking glasses 2 that are on the players' placemats 14. The team members not blindfolded as part of this challenge assist the blindfolded players by placing each beverage in the player's hands. Once each of the participating players have smelled the beverage once, the timer is started. The players may choose to smell the beverages again and may do so as long as they are within the time allotted. The blindfolded players then choose which beverage he or she believes was selected by the opposing captain. If the players are unanimous in choosing the correct beverage, their team will receive a label piece. If at least one player chooses incorrectly, then the opposing team rolls the die and takes their turn. The players that are blindfolded in subsequent group challenges will rotate, so that each player will have an opportunity to participate in a group challenge.

The corners of the game board 12 may be designated as “Steal the Source” spaces. When a team's game piece 6 lands on a Steal the Source space, that team may choose to have a player from the opposing team to either perform a challenge or ask them a question from the General Information Cards or the Specific Information Cards. If the opposing player is not successful in performing the challenge or in answering the question, then the opposing player's team will lose a label piece or their full label depending on the version played. In the fast version of the game, the team that loses the challenge will be required to give one of their completed labels to the opposing team. In the slow version of the game, the team that loses the challenge will be required to give up one piece of their label. In both version, if the team has no label or label piece to give up, then that team will lose a turn and play will continue. If the player is successful in performing the challenge or in answering the question, then that team will not lose a label piece and it will become that team's turn to roll the die.

Each team continues to alternate turns by rolling the die and performing the actions required by the game board spaces. The round will continue until one team has acquired a complete beverage label. At the end of a predetermined number of rounds, the team that has the most completed labels will be declared the winner.

Embodiments of the present game allow the players to learn detailed characteristics of numerous beverages and the regions in which they are grown, without limiting the players to those particular beverages each time the game is played. For example, in one game, players may wish to play using wines from the west coast of the United States. In the first round the teams may play with a pinot noir wine and a sauvignon blanc wine made in Napa Valley, Calif. In the next round, the players may switch to wines made in Oregon, wherein the players would switch the maps, labels, and Specific Information cards between the two rounds. The third round might then involve wines that are produced in the state of Washington. Likewise, in a subsequent game, the players could use different maps, labels, and Specific Information cards, so as to learn about wines produced in various regions of France. In this way the players can “travel” from one region to the next and gain a broad, yet detailed, knowledge of the various wines available. The same is also true for embodiments covering other beverages, such as coffee or beer.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of playing a beverage game comprising the steps of: allowing the player to smell an item associated with a beverage; requiring the player to identify the item based on the scent of the item; allowing the player to obtain a part of a beverage label upon providing a correct identification.

2. A method of playing a beverage game comprising the steps of: blindfolding a player; allowing the player to taste an item associated with a beverage; requiring the player to identify the item based on the taste of the item; allowing the player to obtain a part of a beverage label upon providing a correct identification.

3. A method of claim 1 further comprising: using a chance device to determine the number of spaces that a selected player can move said selected game piece around playing spaces of a game board in a given turn; moving said game piece to a playing space determined by the chance device; determining that the playing space requires the player to identify a smell.

4. A method of claim 2 further comprising: using a chance device to determine the number of spaces that a selected player can move said selected game piece around playing spaces of a game board in a given turn; moving said game piece to a playing space determined by the chance device; determining that the playing space requires the player to identify a taste.

5. A method of claim 1 wherein the steps of claim 1 are repeated throughout the game for a plurality of beverages, and wherein the plurality of beverages originate from a particular geographic region.

6. A method of claim 5 wherein the steps of claim 1 are repeated in a plurality of rounds and wherein the beverages of a particular round all come from a particular geographic region.

7. A method of claim 6 wherein the geographic region changes between each round.

8. A game comprising: a game board having a plurality of playing spaces, and a plurality of maps that are removably attachable to the game board, wherein said maps represents geographic regions in which a type of beverage is produced.

9. A game of claim 8, wherein the maps are attached to said game board by a magnet.

10. A game of claim 8, wherein the maps are attached to said game board by a mechanical fastener.

11. A game of claim 8, wherein the maps are attached to said game board by Velcro.

12. A game of claim 8, further consisting of a plurality of placemats that can be placed around the game board, and each placemat having a removably attachable placemat map.

13. A game of claim 12, wherein the placemat maps represent a geographic region in which a beverage is produced.

14. A game of claim 12, further comprising a beverage label, wherein the beverage label may be removably attached to the placemat.

15. A game of claim 8, further comprising a beverage label that may be placed around the game board, said beverage label having a plurality of beverage label pieces, wherein the beverage label pieces are removably attachable to the beverage label.

16. A game of claim 15, wherein each label piece contains a particular designation relating to a beverage.

17. A game of claim 8 wherein the game board may contain a plurality of maps at one time, and wherein a subset of the plurality of maps represent a geographic region with varying degrees of specificity.

18. A game comprising: a game board, a plurality of game pieces, and a plurality of maps, each illustrating a region in which a beverage is associated, wherein a subset of the game pieces are independent of the region and wherein a subset of the game pieces are specific to the region.

19. A game of claim 18 wherein the game pieces include a plurality of cards, and wherein subset of the cards are region independent and a subset of the cards are region specific.

20. A game of claim 18, wherein the subset of region dependent game pieces includes beverage labels having interchangeable label pieces.
